(19) United States
(12) Patent Application Publication
(10) Pub. No.: US 2005/0096957 A1
(43) Pub. Date: May 5, 2005

(54) System and method for manufacturing job rescheduling

(76) Inventors: Deia Salah-Eldin Bayoumi, Fuquay Varina, NC (US); William John Vick, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/698,772

(22) Filed: Oct. 31, 2003

(51) Int. Cl. G06F 17/60

(52) U.S. Cl. 705/8; 705/2

(57) ABSTRACT

A method for automated manufacturing job reassignment comprises receiving status and notification data from a workstation controlling a manufacturing machine. A query is executed to determine whether the data indicates the machine has become unavailable. If so, a second query is executed to identify a replacement machine having substantially the same functional capabilities as the machine that has become unavailable. The manufacturing schedule is updated and the workstations controlling operation of the manufacturing machines are notified that jobs previously assigned to the unavailable machine are now to be performed at the identified replacement machine.

### CROSS-REFERENCE TO RELATED APPLICATIONS

This application is related by subject matter to U.S. patent application No. (not yet assigned) (Attorney Docket No. ABDT-0576) entitled “System and Method for Integrating Transactional and Real-Time Manufacturing Data” and filed on Oct. 31, 2003, the content of which is hereby incorporated by reference in its entirety.

### FIELD OF THE INVENTION

The disclosed systems and methods relate generally to business management systems and manufacturing control systems.

### BACKGROUND OF THE INVENTION

Modern manufacturing systems often comprise multiple machines, with each machine performing a particular specialized function. For example, in the context of a manufacturing system dedicated to manufacturing distribution transformers, a first machine may be dedicated to cutting, another to winding, a third to annealing, and still others dedicated to performing additional functions. The individual machines are typically connected to and controlled by computer systems.

In high volume manufacturing systems, there may be multiple manufacturing and assembly lines. For example, there may be at least two separate manufacturing lines, with each line comprising a machine dedicated to cutting materials, a machine dedicated to winding, a third machine dedicated to annealing, and so on. Typically, where there are multiple manufacturing lines, the manufacturing lines operate in parallel but independent of each other. Thus, in each manufacturing line, work product is passed from the beginning of the line, through the middle, and results in a finished product at the end of the same line on which the work product began processing.

Breakdowns and/or malfunctions in any one machine on a manufacturing line can cause the entire manufacturing process to be delayed. Generally, existing systems rely upon manual reassignment of the jobs to other machines, perhaps on other manufacturing lines, when such a breakdown occurs. Applicants have noted that manual reassignment and rescheduling of manufacturing jobs is time-consuming and subject to human error.

### SUMMARY

Applicants disclose herein illustrative systems and methods for automated reassignment of jobs in a manufacturing control system. The automated reassignment systems and methods detect that a manufacturing machine has become inoperable, identifies another machine that can fill-in for the failed system, and rescheduled jobs originally to be performed by the failed machine to the identified machine. The automated reassignment saves time, preserves existing manufacturing schedules, and provides for near optimal machine utilization.

An illustrative system for automatically reassigning manufacturing jobs comprises a plurality of manufacturing machines, a plurality of operator workstations for controlling the manufacturing machines and for receiving status and notification from the manufacturing machines, a process server adapted to receive the status and notification data from the operator workstations, and a database comprising information regarding the plurality of manufacturing machines. More particularly, the database comprises data specifying the functional capabilities of each of the plurality of manufacturing machines.

In an illustrative method described in detail below, when an operator workstation receives a status notification that a manufacturing machine has become inoperable, i.e. failed, it forwards this notification to the process server. The process server queries the database to identify another manufacturing machine that can perform the functions of the failed machine. After a second manufacturing machine is identified, the process server communicates with the operator workstations associated with the second machine identified in the search and the failed machine to reschedule the jobs originally intended for the failed machine. If the process server later receives status and notification data indicating the failed machine has been restored to an operable state, the process server may communicate with the operator workstations controlling the second manufacturing machine and the previously failed machine to schedule jobs to be completed at the restored machine.

### BRIEF DESCRIPTION OF THE DRAWINGS

Other features of the illustrative system and method will be further apparent from the following detailed description taken in conjunction with the accompanying drawings, of which:

FIG. 1 is a diagram of an illustrative system for manufacture of a distribution transformer;

FIG. 2 is a software block diagram of an illustrative system for manufacture of a distribution transformer;

FIG. 3 is a diagram of an illustrative system for reassigning manufacturing jobs;

FIG. 4 is a diagram of an illustrative system for reassigning manufacturing jobs;

FIG. 5 is a diagram illustrating the flow of data in an illustrative system for reassigning manufacturing jobs;

FIG. 6 is a flow chart of an illustrative method for reassigning jobs in a manufacturing system; and

FIG. 7 is a diagram of an illustrative computer system for use in the illustrative systems and methods.

### DETAILED DESCRIPTION OF ILLUSTRATIVE EMBODIMENTS

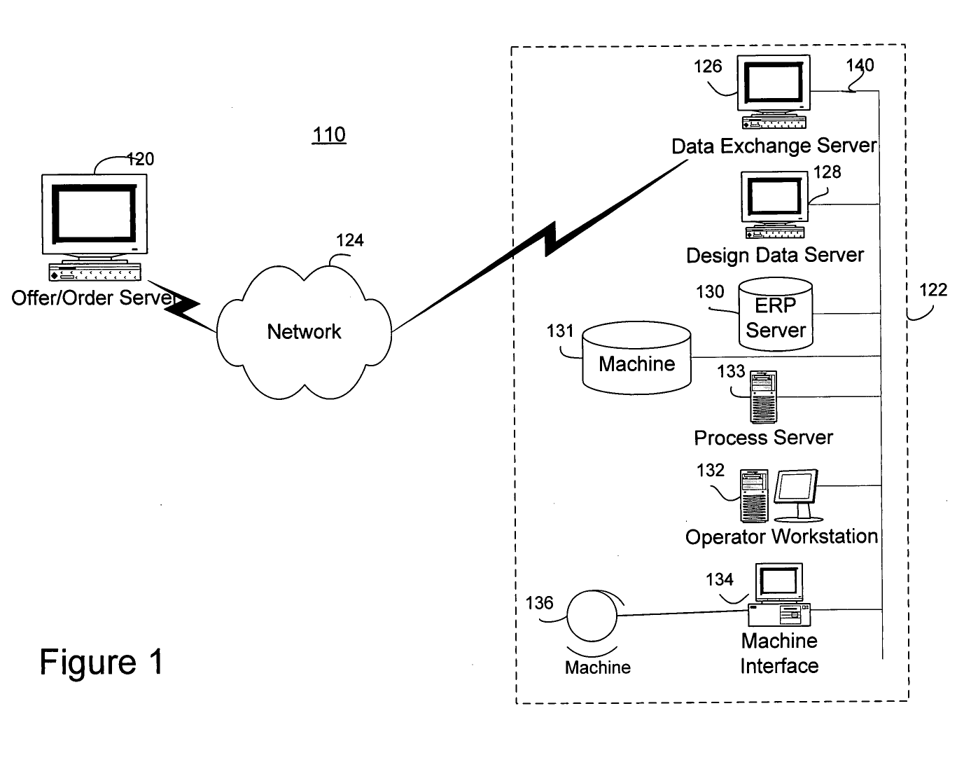

FIG. 1 is a diagram of an illustrative system 110, which may be employed to manufacture many different types of articles. For purpose of discussion, system 110 is described as being adapted to manufacture distribution transformers, although it could be used to manufacture all types of articles. As shown in FIG. 1, system 110 comprises offer/order server 120 which is employed to receive offers and orders for distribution transformers. Offer/order server 120 communicates offers and orders for transformers via network 124 to manufacturing facility 122. Network 124 may comprise wireless connectivity, wire based technology, or both. Further, network 124 may comprise private networks and public networks such as, for example, the Internet.

Manufacturing facility 122 is adapted to respond to orders received from network 124 and manufacture distribution transformers using the methods described below. Manufacturing facility 122 comprises data exchange server 126 which is adapted to receive customer offers from offer/order server 120 via network 124. Data exchange server 126 communicates over LAN 140 with process server 133, operator workstation 132, and ERP server 130 to determine whether there is the capacity at the particular manufacturing facility 122 to manufacture an item specified in an order as well as to control the manufacture of that item.

ERP server 130 is an ERP business application server that provides access to transactional data such as, for example, sales, bills of material, planning, manufacturing routing, inventory, and procurement data. This data may be accessed on demand whenever necessary and is updated when there are developments in the system that change the data. During operation of the manufacturing system, ERP server 130 is accessed to retrieve, for example, information relating to the orders to be filled as well as the production schedule. The transactional data stored in ERP server is updated during the manufacturing process to reflect changes in the inventory of raw materials, in schedules, and the inventory of completed and partially completed product that have resulted from the ongoing manufacturing process.

Design data server 128 has stored thereon and provides access to design data for distribution transformers that have been manufactured at or are scheduled to be manufactured at the particular manufacturing facility 122. Design data server 128 comprises the electrical and manufacturing design data for the transformers along with the machine instructions for performing the manufacturing operations necessary to make the transformer. In one embodiment, design data server 128 may comprise, for example electronic drawings, e.g. CAD drawings, that specify the components and measurements for the distribution transformers. The specification data on design data server 128 may be accessed by process server 133 and operator workstation 132 for use in the manufacture of an item specified in a new order.

Machine attribute database 131 comprises data regarding the manufacturing machines 136 located at facility 122. More particularly, machine attribute database 131 may comprise specifications, functional capabilities, and scheduled capacity for each machine 136 at facility 122. Further, database 131 may comprise data specifying the routing characteristics and schedules for each machine 136. Finally, database 131 may comprise data specifying the meaning of various notification, status, and alarm data that are generated by machines 136 and transmitted to process server 133.

Process server 133 operates to coordinate the scheduling of manufacturing jobs at various machines 136 at facility 122. As described in detail below, process server 133 receives status and notification data from operator workstations 132 during the manufacturing process. If the status or notification data indicates a particular machine has become unavailable, process server 133 queries machine attribute database 131 to identify another machine 136 at facility 122 that has substantially the same functional capabilities and a schedule that will allow for receiving jobs originally scheduled to be completed by the now unavailable machine. Upon identifying such a machine, process server 133 communicates, possibly via data exchange server 26, updated schedules to the appropriate operator workstations 132 associated with the failed machine and the identified replacement machine. The updated schedules move jobs originally scheduled to be completed by the failed machine to the replacement machine.

Operator workstation 132 is adapted to allow an operator to control the manufacture of items at facility 122. More particularly, operator workstation 132 provides a user interface that allows an operator to start, stop, re-start, and terminate the manufacture of transformers. Operator workstation 132 communicates over LAN 140 with machine interface computer 134 to control the operation of manufacturing machines 136. Operator workstation 132 communicates control signals to machine interface 134 and thereby causes machine(s) 136 to perform certain manufacturing processes. Machine interface 134 communicates directly with machine(s) 136 and relays any feedback data including status, notifications, and alarms back to operator workstation 132. Operator workstation 132 forwards status, notification, and alarm information back to process server 133 for additional evaluation. The manufacturing jobs and schedules that are assigned to operator workstations 132 originate at, and may be modified by process server 133.

Machines 136 are adapted to physically create a distribution transformer and are controlled by operator workstation 132 via machine interface 134. Machines 136 may be adapted to perform activities for the manufacture of a distribution transformer such as, for example, cutting, winding, annealing, etc. Generally, machines 136 are adapted to communicate in OPC standard protocols, although other protocols may be used.

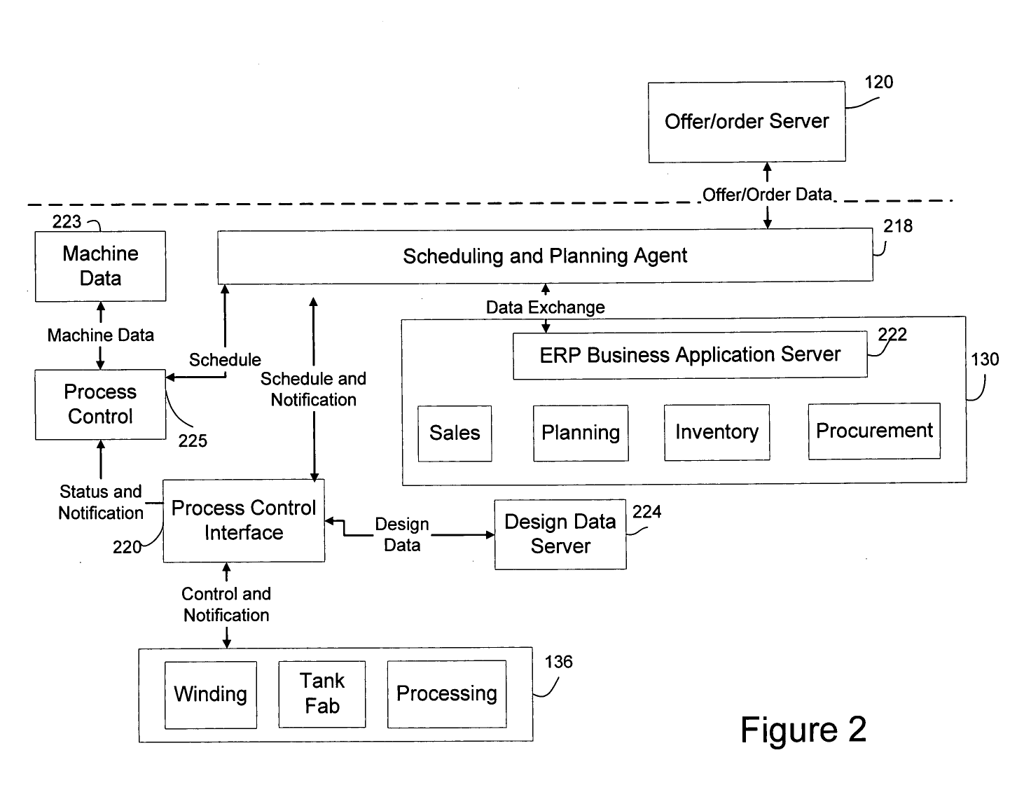

FIG. 2 is a block diagram illustrating software components and data flow in an illustrative system for manufacturing a distribution transformer. As shown, offers and orders for distribution transformers are received from offer/order server 120. Offer and order data are received at scheduling and planning agent software 218, which executes on data exchange server 126. Scheduling and planning agent software 218 queries ERP business application server software 222 and process control interface software 220 executing on workstations 132 to determine whether the particular manufacturing facility 122 has the capability and schedule of production which will allow for the manufacture of the item specified in the customer offer.

During manufacture of a distribution transformer, process control interface software 220 receives design data from design data server software 224 and machine data from machine data server software 223. Process control interface software 220 communicates control data via computer interface 134 to machines 136, and receives status and event notification from machines 136. Process control interface software 220 forwards event notification and status data to process control server software 225 and scheduling and planning agent software 218.

Process control server software 225 monitors the status and notification data from process control interface 220 and may query machine data server software 223 as described below in response to the status and notification data. Control server software 225 may forward updated scheduling information to process control interface 220 via scheduling and planning agent 218 as described below to cause jobs to be reassigned from one machine to another.

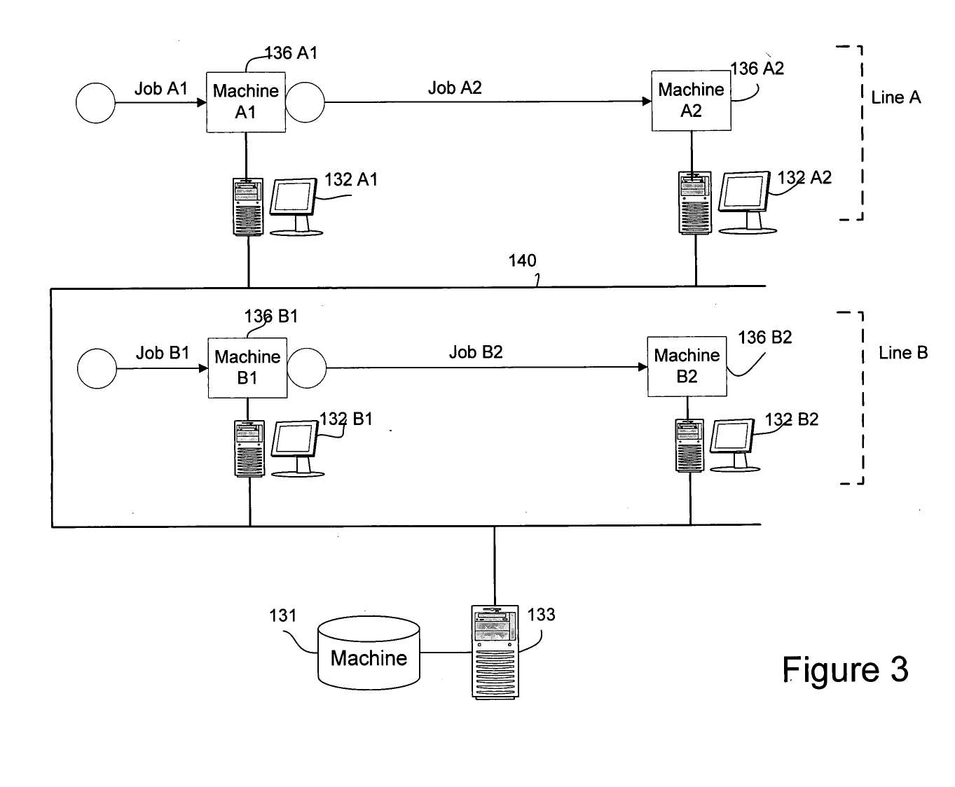

FIG. 3 is a diagram of a simplified manufacturing system operating under normal manufacturing conditions, i.e. when all manufacturing machines are operable. As shown, a first manufacturing line A comprises manufacturing machine 136 A1 and machine 136 A2. A second manufacturing line B comprises machines 136 B1 and 136 B2. Those skilled in the art will recognize that while manufacturing lines A and B are illustrated as comprising only two machines each, both lines may comprise any number of machines and corresponding controllers. Machines 136 A1, A2, B1, and B2 are communicatively coupled to and controlled by operator workstations 132 A1, A2, B1, and B2, respectively. Thus, machines 136 A1, 136 A2, 136 B1, and 136 B2 respond to commands received from operator workstations 132 A1, 132 A2, 132 B1, and 132 B2, respectively. An operator using operator workstations 132 A1, 132 A3, 132 B1, and 132 B2 is able to start jobs, stop jobs, and view information about the processing at the corresponding machine. Workstations 132 A1, A2, B1, and B2 receive status and notification data, including alarm data, from machines 136 A1, A2, B1, and B2.

Operator workstations 132 A1, 132 A2, 132 B1, and 132 B2 communicate over network 140 with process server 133. More particularly, operator workstations 132 A1, 132 A2, 132 B1, and 132 B2 communicate notification and status information, including alarm notifications, about the processing occurring at machines 136 A1, 136 A2, 136 B1, and 136 B2 to process server 133 as described below. Process server 133 communicates in the manner described below with each of workstations 132 A1, 132 A2, 132 B1, and 132 B2 to control the operations of manufacturing lines A and B. For example, process server 133 dictates which jobs are assigned to each of machines 132 A1, 132 A2, 132 B1, and 132 B2.

During normal manufacturing procedures, line A and line B operate independently of each other. Thus, machine 136 A1 performs job A1 and thereafter machine 136 A2 performs job A2. Similarly, machine 136 B1 performs job B1 and thereafter machine 136 B2 performs job B2. Status and notification data originating at machines 136 A1, 136 A2, 136 B1, and 136 B2 is forwarded via workstations 132 A1, 132 A2, 132 B1, and 132 B2 to process server 133. Process server queries machine database 131 to determine the meaning of the status and notification data and whether an action needs to be taken in light of the status data.

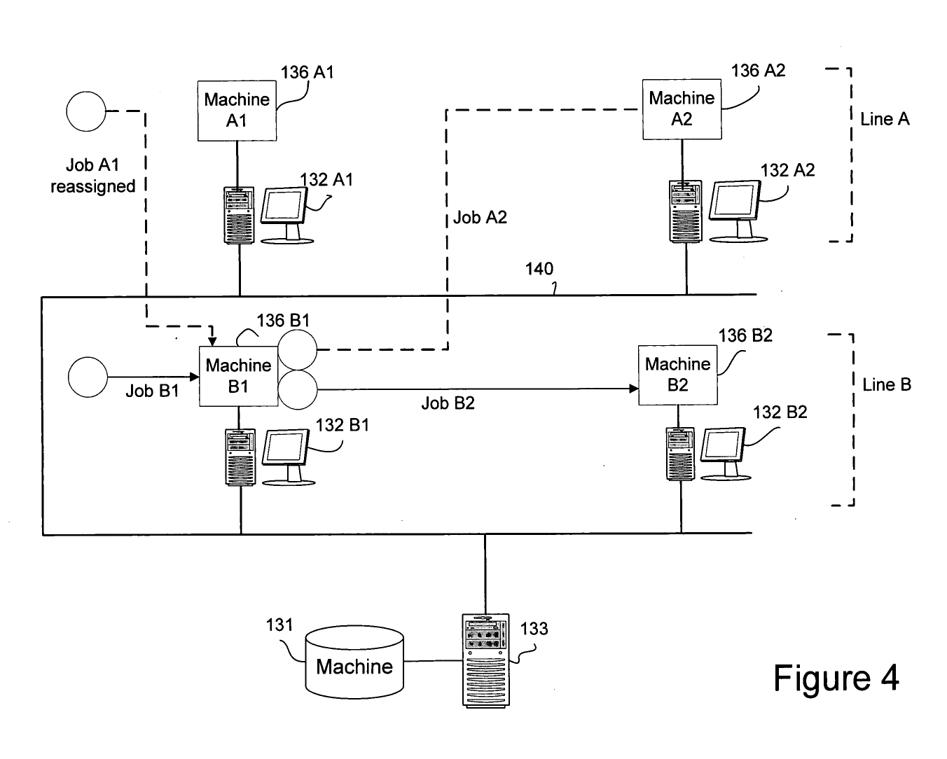

FIG. 4 is a diagram of simplified manufacturing system wherein machine 136 A1 is unavailable. Machine 136 A1 may have become unavailable for any number of reasons including, for example, a mechanical failure, a software failure, or a human error. If machine 136 A1 becomes unavailable, status and notification data indicating the machine is unavailable is transmitted by workstation 132 A1 via network 140 to process server 133. Process server 133 queries machine database 131 and identifies that workstation 132A1 is unavailable. Process server 133 queries database 131 again to identify a machine with substantially the same functionality as unavailable machine 136 A1. For purposes of illustration, it is assumed that the query identifies machine 136 B1 as having substantially the same functionality as machine 136 A1. Thereafter, process server 133 communicates new job schedules to workstations 132 A1, 132 A2, 132 B1, and 132 B2. The new job schedules specify that job A1 is now to be performed by machine 136 B1. The schedule may indicate the product resulting from job A1 is to be forwarded on to machine 136 B2 for completion of job A2. Machine 136 B1 continues to complete job B1 while filling in for machine 136 A1.

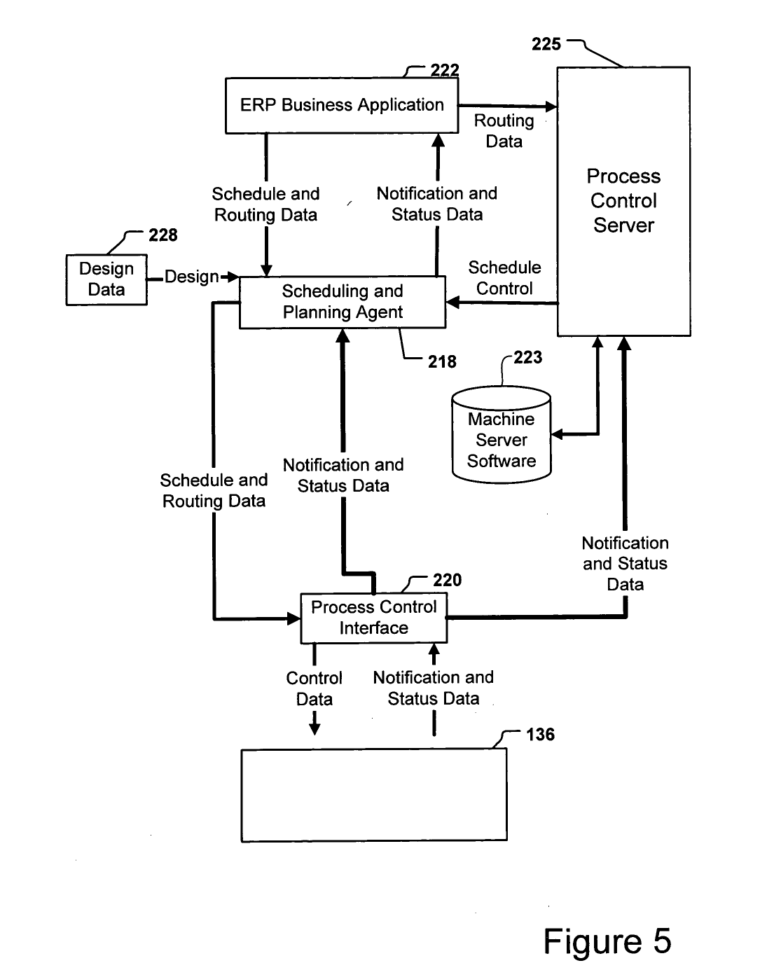

FIG. 5 provides a diagram depicting the flow of data during the manufacture of an ordered transformer. As shown, when manufacture of an item is initiated, planning data including scheduling and routing data relating to the manufacture of an ordered transformer is retrieved from ERP business application server 222 to scheduling and planning agent 218. For example, bill of material, routing, and material availability data may be retrieved from server 222 to scheduling and planning agent 218. Scheduling and planning agent 218 requests and receives design data from design data server 228. For example, drawings for the transformer and machine instructions for manufacturing the transformer may be received by scheduling and planning agent 218. The schedule data and design data are routed to process control interface 220. Process control interface 220 employs the schedule and design data to control manufacturing machines 136 via interface 134 (not shown). During the manufacture of the item, machines 136 transmit event notification and alarm data to process control interface 220. Process control interface 220 transmits the event notification data to process control server 225 and scheduling and planning agent 218, which updates ERP business server 222 to reflect the notification data as described in detail in related U.S. patent application No. (not yet assigned) (Attorney Docket No. ABDT-0576) entitled “System and Method for Integrating Transactional and Real-Time Manufacturing Data” and filed on Oct. 31, 2003, the content of which is hereby incorporated by reference in its entirety. Process control server 225 queries machine server software 223 to retrieve information about the status and notification data that was forwarded. If the status and notification data indicate a machine has become unavailable, process control server queries server software 223 to identify a machine that has substantially the same capabilities as the unavailable machine. Process control server software 225 may communicate manufacturing schedule updates to scheduling and planning agent 218. These updates are then communicated to process control interface software 220 operating on machines 136. Thus, process control server software 225 reacts to status and notification data from process control interface 220 to automatically make adjustments to the job schedule.

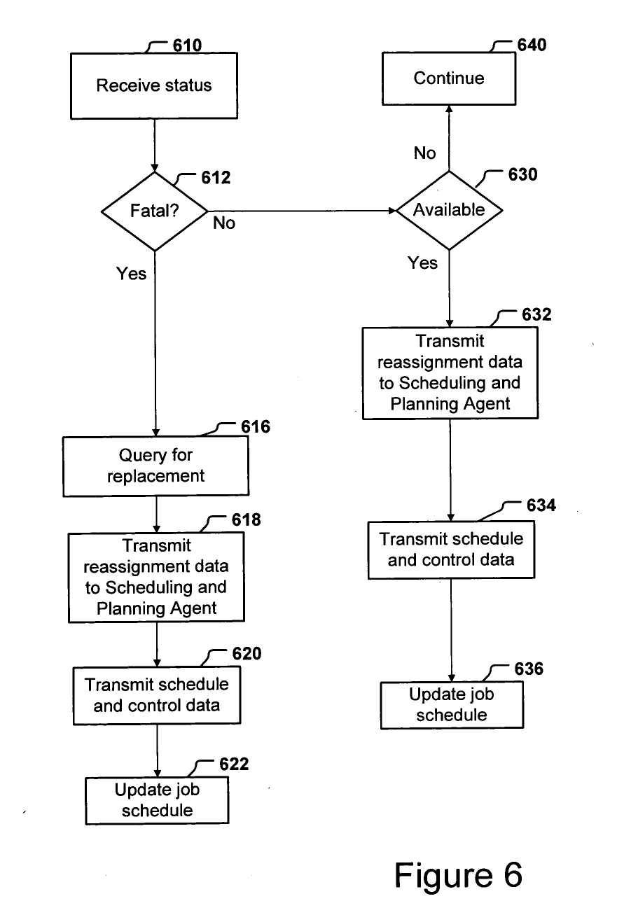

FIG. 6 is a flow diagram of a process for rescheduling jobs in a manufacturing system. As shown, at step 610 process server 133 receives status and notification data from process control interface software 220 operating on a workstation 132 such as workstation 132 A1. At step 612, process server 133 queries machine database software 223 operating on machine database server 131 to determine whether the status and notification data indicate a fatal error has occurred. If so, at step 616 process control server software 225 operating on server 133 queries machine database software 223 executing on database server 131 for a replacement machine. More particularly, a query is executed for a machine having substantially the same capabilities as the failed machine and which has a schedule that will accommodate additional jobs. For example, the query might indicate machine 136 B1 is operable to replace machine 136 A1. After a replacement machine is identified, at step 618 instructions to reassign jobs currently scheduled to be completed by the failed machine to the replacement machine are transmitted by process server 133 to scheduling and planning agent 218. For example, the instructions may indicate the jobs originally scheduled to be completed by machine 136 A1 are to be reassigned to replacement machine 136 B1. At step 620, the new schedule is transmitted to the process control interface software 220 executing on workstations 132 A1, A2, B1, and B3. For example, the instructions may be forwarded by scheduling and planning agent 218 to workstations 132 A1, A2, B1, and B3. At step 622, the ERP data is updated to reflect the new manufacturing schedule.

If at step 612, the status and event notification do not indicate a machine has become unavailable, e.g. failed, then at step 630 it is determined whether the status and notification data indicate the previously failed machine has been reactivated. For example, at step 630, process server 133 queries machine database software 223 operating on machine database server 131 to determine whether the status and notification data indicate the previously failed machine has been reactivated. For example, the data may indicate machine 136 A1 which had previously failed is now reactivated. If the machine has been reactivated, at step 632 instructions to reassign jobs from the replacement machine to the original or reactivated machine are transmitted by process server 133 to scheduling and planning agent 218. For example, the instructions may indicate the jobs scheduled to be completed by machine 136 B1 are to be reassigned to reactivated machine 136 A1. At step 634, the new schedule is transmitted to the process control interface software 220 executing on workstations 132 A1, A2, B1, and B3. For example, the instructions may be forwarded by scheduling and planning agent 218 to workstations 132 A1, A2, B1, and B3. At step 622, the ERP data is updated to reflect the new manufacturing schedule.

If at step 630 the status and event notification do not indicate the previously failed machine has been activated, at step 640 processing of that event notification continues as appropriate. For example, the status and event notification data may identify that an event in the manufacturing process has been completed, in which case at step 640 the ERP data may be updated to acknowledge the event has taken place.

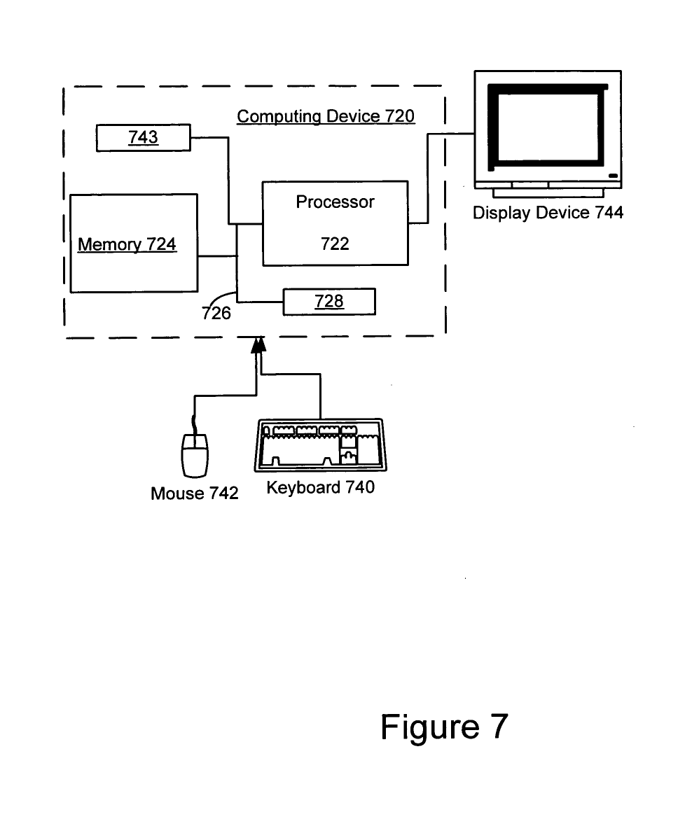

FIG. 7 is a diagram of an illustrative computing system that may be used to implement any of computing systems 120, 126, 128, 130, 131, 132, 133 and 134 discussed above. As shown in FIG. 7, computing device 720 includes processor 722, system memory 724, and system bus 726 that couples various system components including system memory 724 to processor 722. System memory 724 may include read-only memory (ROM) and/or random access memory (RAM). Computing device 720 may further include hard-drive 728, which provides storage for computer readable instructions, data structures, program modules, data, and the like. A user (not shown) may enter commands and information into computing device 720 through input devices such as keyboard 740 or mouse 742. Of course different input devices such as a telephone or PDA keypad or voice recognition input apparatus may also be used. A display device 744, such as a monitor, a flat panel display, or the like is also connected to the computing device 720 or output. Display device 744 may also include other devices such as a touch screen for inputting information into processor 722. Communications device 743, which may be a modem, network interface card, or the like, provides for communications over networks 124 and 140.

Processor 722 can be programmed with instructions to interact with other computing systems so as to perform the methods described above. The instructions may be received from network 140 or stored in memory 724 and/or hard drive 728. Processor 722 may be loaded with any one of several computer operating systems such as WINDOWS NT operating system, WINDOWS 2000 operating system, LINUX operating system, PalmOS, and the like.

Those skilled in the art understand that computer readable instructions for implementing the above-described processes, such as those described with reference to FIGS. 3 through 6 can be generated and stored on one of a plurality of computer readable media such as a magnetic disk or CD-ROM. Further, a computing device such as that described with reference to FIG. 7 may be arranged with other similarly equipped computers in a network, and may be loaded with computer readable instructions for performing the above described processes. Specifically, referring to FIG. 7, microprocessor 722 may be programmed to operate in accordance with the above-described processes.

Thus, systems and methods for automated reassignment of manufacturing jobs have been disclosed. According to the disclosed systems and methods, when notification is received that a manufacturing machine has become unavailable, a query is made to identify a suitable replacement machine. The job schedules of the workstations controlling the manufacturing machines are updated to transfer responsibility for completing the jobs originally scheduled for the unavailable machine to the replacement machine. Therefore, when machines fail or otherwise become unavailable, the manufacturing process can continue using alternative resources available at the facility. Accordingly, the illustrative systems provide improved reliability and maximize resource utilization.

While the disclosed systems and methods have been described and illustrated with reference to specific embodiments, those skilled in the art will recognize that modification and variations may be made. For example, while the disclosed embodiments relate to manufacture of distribution transformers, the disclosed systems and methods may be employed to control the manufacture of any type of item. Further, while the illustrative systems comprise production lines comprising two machines each, the novel systems and methods may be applied to systems comprising any number of machines. Accordingly, reference should be made to the appended claims as indicating the scope of the invention.

1. A computer-implemented method of reassigning jobs in a manufacturing system, comprising:
receiving status data relating to a first manufacturing machine scheduled to perform a job;
determining whether the status data indicates the first manufacturing machine is unavailable to perform the job; and
if the status data indicates the first manufacturing machine is unavailable, identifying a second manufacturing machine operable to perform the job, and reassigning the job from the first manufacturing machine to the second manufacturing machine.

2. The method of claim 1, wherein receiving status data relating to a first manufacturing machine comprises receiving data indicating the first manufacturing machine is malfunctioning.

3. The method of claim 1, wherein determining whether the status data indicates the first manufacturing machine is unavailable to perform the job comprises determining the first manufacturing machine is malfunctioning.

4. The method of claim 1, wherein determining whether the status data indicates the first manufacturing machine is unavailable comprises querying a database to determine a meaning for the status data.

5. The method of claim 1, wherein identifying a second manufacturing machine operable to perform the job comprises querying a database for a machine operable to perform the job.

6. The method of claim 1, wherein reassigning the job from the first manufacturing machine to the second manufacturing machine comprises transmitting instructions to schedule the job for performance at the second manufacturing machine.

7. The method of claim 1, further comprising transmitting instructions to update a schedule to indicate the job has been reassigned from the first manufacturing machine to the second manufacturing machine.

8. The method of claim 1, further comprising determining whether the status data indicates the first manufacturing machine is available.

9. The method of claim 8, wherein determining whether the status data indicates the first manufacturing machine is operable to perform the job.

10. The method of claim 8, further comprising reassigning the job from the second manufacturing machine to the first manufacturing machine.

11. The method of claim 10, wherein reassigning the job from the second manufacturing machine to the first manufacturing machine comprises transmitting instructions to schedule the job for performance at the first manufacturing machine.

12. The method of claim 10, further comprising transmitting instructions to update a schedule to indicate the job has been reassigned from the second manufacturing machine to the first manufacturing machine.

13. A computer-implemented method of reassigning manufacturing jobs in a manufacturing system, comprising:
maintaining a database identifying characteristics of a plurality of manufacturing machines;
receiving notification that a first manufacturing machine is unavailable to perform a manufacturing job;
querying the database to identify a second manufacturing machine operable to perform the manufacturing job; and
rescheduling the job to be performed by the first manufacturing machine to the second manufacturing machine.

14. The method of claim 13, wherein maintaining a database identifying characteristics of a plurality of manufacturing machines comprises maintaining a database comprising data specifying the functional capabilities of a plurality of manufacturing machines.

15. The method of claim 13, wherein receiving notification that first manufacturing machine is unavailable to perform a manufacturing job comprises receiving data indicating the first manufacturing machine is malfunctioning.

16. The method of claim 13, wherein querying the database to identify a second manufacturing machine comprises querying to identify a manufacturing machine having substantially same manufacturing capabilities as the first manufacturing machine.

17. The method of claim 13, wherein rescheduling the job to be performed by the first manufacturing machine to the second comprises updating scheduling data to reflect the job to be performed by the second manufacturing machine.

18. The method of claim 13, wherein receiving notification that a first manufacturing machine is unavailable to perform a manufacturing job comprises receiving notification that a first manufacturing machine is malfunctioning.

19. A system for rescheduling manufacturing jobs, comprising:
a database comprising data regarding the characteristics of a plurality of manufacturing machines; and
a server communicatively coupled to said database, said server adapted to receive notification that a first manufacturing machine is unavailable to perform a job scheduled to be performed by the first manufacturing machine, query said database to identify a second manufacturing machine available to perform the job, and reschedule the job to be performed by the second manufacturing machine.

20. The system of claim 19, further comprising a scheduling and planning agent communicatively coupled to said server, wherein said server reschedules the job to be performed by the second manufacturing machine by transmitting a request to reschedule the job to said scheduling and planning agent.
